(19) United States
(12) Patent Application Publication
(10) Pub. No.: US 2024/0003340 A1
(43) Pub. Date: Jan. 4, 2024

(54) SPRING DRIVE APPARATUS

(71) Applicant: Cloyce Milton Harlan, Edmond, OK (US)

(72) Inventor: Cloyce Milton Harlan, Edmond, OK (US)

(21) Appl. No.: 18/344,779

(22) Filed: Jun. 29, 2023

Related U.S. Application Data
(60) Provisional application No. 63/357,315, filed on Jun. 30, 2022.

(51) Int. Cl. F03G 1/06

(52) U.S. Cl. CPC F03G 1/06

(57) ABSTRACT

A spring drive motor is presented herein. The motor includes a rotatable cam shaft with a plurality of cams axially spaced there along and rotatable therewith. Each of the cams include a circular shape with at least one portion defined by a linear outer surface. A plurality of rocker arms, each of which correspond with a different one of the plurality of cams, are mounted at one end to a pressure bar assembly and at another end to a power unit. The power unit is defined as comprising an upper spring cup, a lower spring cup and a spring mounted there between. Each upper spring cup is mounted to a crank shaft between adjacently disposed disk-shaped crank members. Lowering the pressure bar assembly engages the rocker arms and activates rotation of the cam shaft and crank shaft through compression and expansion of the springs.

### CLAIM OF PRIORITY/CROSS-REFERENCE TO RELATED APPLICATION

The present application is based on and a claim of priority is made under 35 U.S.C. § 119(e) to provisional patent application Ser. No. 63/357,315, filed on Jun. 30, 2022, the contents of which are incorporated herein in their entirety by reference.

### FIELD OF THE INVENTION

The present invention is directed to a spring drive apparatus, and in particular, a spring driven motor with a plurality of rocker arm assemblies and cam members. The rocker arm assemblies are each mounted to a pressure bar at one end and connected to a compressible spring at the other end. During operation of the motor, at least one of the springs is disposed in a compressed state while at least another one of the springs is disposed in a relaxed state.

### BACKGROUND OF THE INVENTION

There is a need in the art for an improved and efficient motor that can provide rotational or other movement to an externally connected device. The proposed motor may operate with a plurality of power units and/or springs that are cooperatively and alternately disposed between different compressed and relaxed states in order to provide and produce power.

### SUMMARY OF THE INVENTION

According to at least one embodiment of the present invention, a spring drive apparatus is provided whereby independent spring force for rotation is continuously delivered by a number of expansible, compressible connecting means operating so that, at any given time, more connecting means are expanding than are being compressed.

As embodied in at least one embodiment, a rotatable cam shaft has axially spaced along its length a number of cams fixed to the shaft for rotation therewith. Each cam has an edge varying in distance from a center of rotation of the cam between a maximum distance and minimum distance. A number of rocker arms, one following each cam, are pivotally attached, in a predetermined position, to the apparatus at one end, and which support at an opposite end expansible, compressible connecting means. A crank shaft having an eccentric crank portion for connection with each connecting means is rotatably driven by rotation of the cam shaft and reciprocal movement of the connecting means.

In at least one embodiment, each cam is shaped so that the maximum distance at its edge extends through a minor portion (about 90°) of its 360° rotation and the minimum distance extends through a larger portion (about 135°) of rotation with a sharp rise from minimum to maximum distance and a gradual decline from maximum to minimum distance as the cam rotates. The arrangement at the edge of the cams provides compression of one connecting means as opposed to expansion of a plurality of other connecting means.

In at least one embodiment, a hydraulic pump may be connected to the cam shaft for rotation with the cam shaft to aid in the operation of a throttle system. The throttle system may be used to control the rest position of the rocker arms by displacing a pressure bar connected to a rocker arm riding on each cam. Adjustment of the rocker arm controls the degree of compression and expansion of each connecting means.

### BRIEF DESCRIPTION OF DRAWINGS

FIG. 1 is a front sectional view of an apparatus as disclosed in accordance with at least one embodiment of the present invention with some portions removed for clarity.

FIG. 2 is an end view of the apparatus illustrated in FIG. 1, with portions remove for clarity.

FIG. 3 is a sectional view of the power unit assembly illustrated in the embodiment shown in FIG. 2.

FIG. 4 is a side view of an alternative cam as disclosed in accordance with at least one embodiment of the present invention.

FIG. 5 is a side view of the motor as disclosed in accordance with at least one embodiment of the present invention showing a timing system thereof.

FIG. 6 is a perspective view of the apparatus as disclosed in accordance with another embodiment of the present invention.

FIG. 7 is another perspective view of the apparatus illustrated in FIG. 6

FIG. 8 is yet another perspective view of the apparatus illustrated in FIGS. 6 and 7.

FIG. 9 is a front sectional and perspective view of the apparatus illustrated in FIGS. 6-8.

FIG. 10 is a left perspective and partial sectional view of the apparatus illustrated in FIGS. 6-9.

FIG. 11 is a front perspective sectional view of the apparatus illustrated in FIGS. 6-10.

FIG. 12 is a front sectional view of the apparatus illustrated in FIGS. 6-11.

FIG. 13 is a partial perspective view of the rocker arm assembly, cam and power unit as disclosed in accordance with at least one embodiment of the present invention.

FIG. 14 is a partial perspective and exploded view of the power unit and rocker arm assembly as disclosed in accordance with at least one embodiment of the present invention.

FIG. 15 is a partial perspective view of the power unit as disclosed in accordance with at least one embodiment of the present invention.

FIG. 16 is a side view of the rocker arm assembly as disclosed in accordance with at least one embodiment of the present invention.

FIG. 17 is a top view of the rocker arm assembly illustrated in FIG. 16.

FIG. 18 is a side sectional view of the apparatus as disclosed in accordance with at least one embodiment of the present invention.

FIG. 19 is another side sectional view of the apparatus as disclosed in accordance with at least one embodiment of the present invention.

FIG. 20 is a perspective, sectional cut-away view illustrating the pressure bar apparatus of at least one embodiment of the present invention, with several components removed for clarity.

FIG. 21 is an exploded and cut-away view of a portion of the positioning assembly for the pressure bar apparatus as disclosed in accordance with at least one embodiment of the present invention.

FIG. 22 is a sectional and partially perspective view of the motor as disclosed in accordance with at least one embodiment of the present invention.

FIG. 23 is sectional perspective view of the motor as disclosed in accordance with at least one embodiment of the present invention.

FIG. 24 is a plan view of the cam as disclosed in at least one embodiment of the present invention.

Like reference numerals refer to like parts throughout the several views of the drawings provided herein.

### DETAILED DESCRIPTION OF THE INVENTION

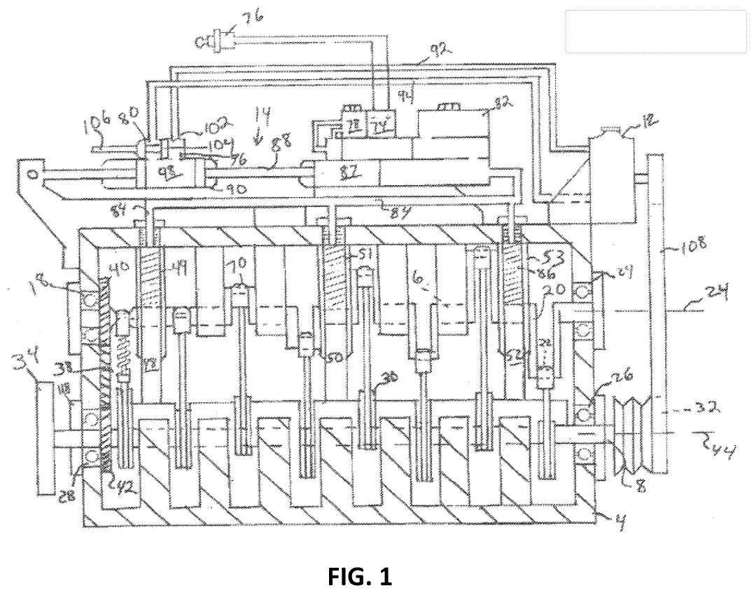

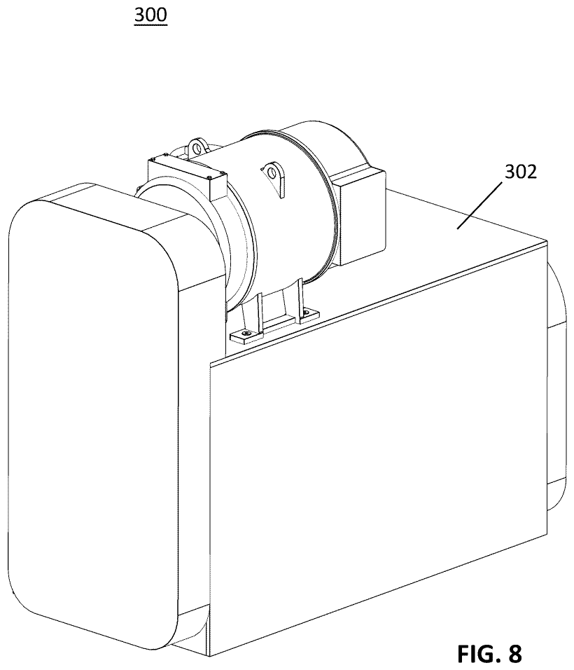

As shown in the accompanying drawings, and with reference first to FIGS. 1, 2, and 6-8 at least one embodiment of the present apparatus is contained in a generally rectangular housing 4. The housing 4, of at least one embodiment, supports or otherwise includes an internal space that maintains a crank shaft 6, a cam shaft 8, and a rocker arm assembly 10. A hydraulic pump 12 and throttle assembly 14 are mounted on the housing 4.

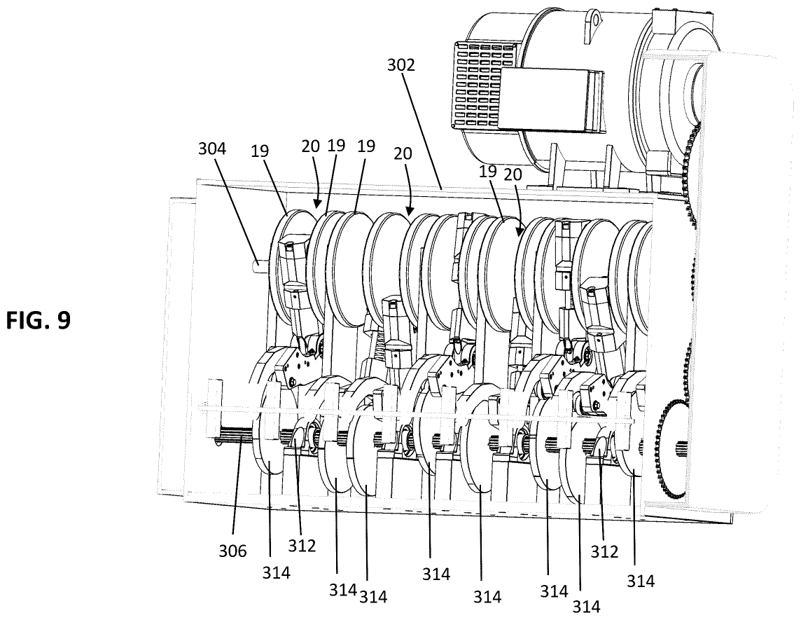

The crank shaft 6 is mounted axially through an upper portion of the housing 4 through forward bearing 16 and rearward bearing 18 and comprises equally axially spaced eccentric crank portions 20 for each cam and connecting means, there being eight in the embodiment illustrated in FIG. 1, for example. Each crank portion 20 comprises a pair of axially spaced members 19 and a cross piece 22 which rotates in a circle of a given diameter Der about the axis of rotation 24 of the crank shaft. One or more crank portions 20 may share a member 19 as shown in FIG. 9.

The cam shaft 8 is supported on a forward bearing 26 and a rearward bearing 28 and, in at least one embodiment, supports eight cams 30 in equally axially spaced relationship along its length, one opposite each crank portion 20. It should be noted that in other embodiments, more of less than eight cams 30 may be included and the spacing of the cams may or may not be equal along the length. Furthermore, in at least one embodiment, and as shown in FIG. 1 for example, the cam shaft 8 terminates forwardly in a pulley wheel 32 and rearwardly in a flywheel 34. The cam shaft 8 may be journaled or splined to support engagement with the plurality of cams 30 for rotation therewith.

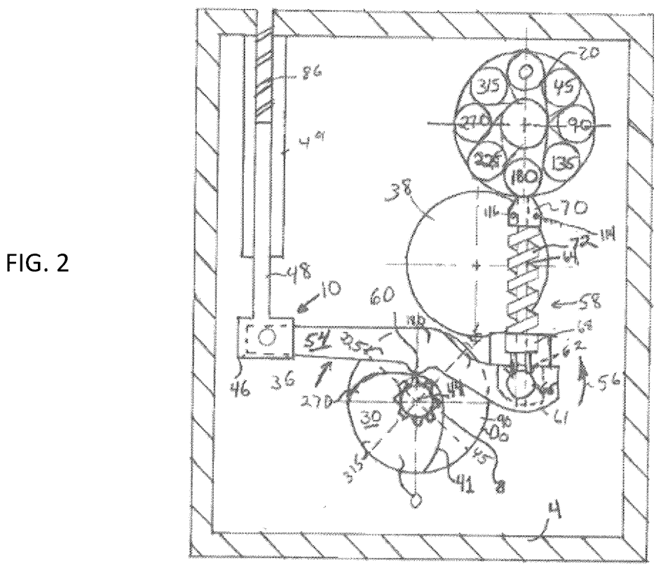

Particularly, in at least one embodiment, the cams 30 are mounted in a circumferentially offset relationship to each other so that each succeeding cam 30 is offset from its rearwardly adjacent cam 30 by 360° divided by the number of cams. In the embodiment shown that has eight cams 30, each succeeding cam is offset from its rearwardly adjacent cam by 45°. Similarly, in the embodiment shown, each crank portion 20 is offset from its rearwardly adjacent crank portion by 45° so that, as shown in FIG. 2, a cam denominated 180 will be oppositely connected to a crank portion having its 180 portion engaging a rocker arm. A cam advanced 45° in the direction of arrow 36 is oppositely connected to a crank portion 225, and so forth. A timing gear 38 engages gears 40, 42 on the crank shaft and cam shaft, respectively, to maintain the cams 30 and crank portions 20 in the above-described predetermined relationship.

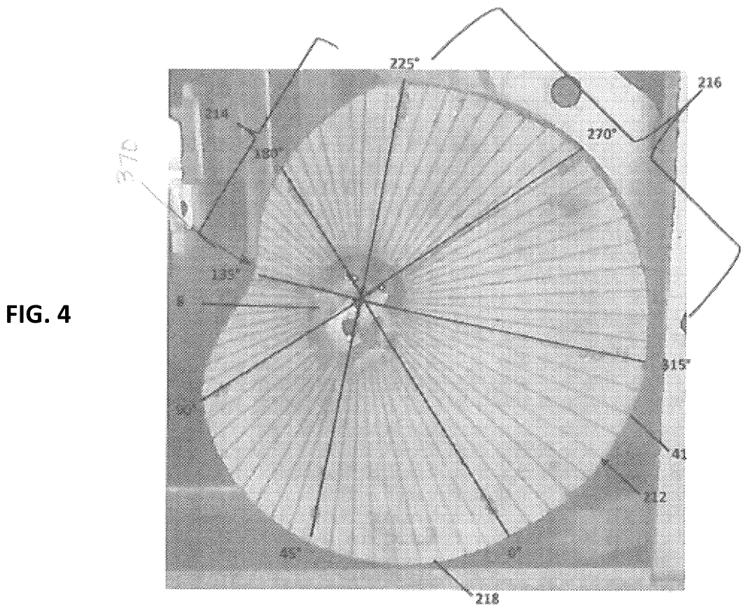

In at least one embodiment, each cam 30 is of the same modified disk shape having modified edge surface 41 as shown in FIG. 2. With reference to FIG. 4, each cam may be divided into eight sectors, 0-360. The edge surface of sectors comprising angles 135-225 are at a minimum distance from the axis 44 of rotation of the cams. Sectors 270 and 225 comprises a rate of 90° and the edge 41 of cam 30, is curved slightly outwardly. From 270° the edge continues at a maximum distance from axis to sector 0, along which it describes a circle of a diameter approximately Der. From sector 0, the cam gradually returns to a minimum distance in the vicinity of sector 90.

With reference to FIG. 2, the rocker arm assembly 10 of at least one embodiment comprises an axially elongated pressure bar 46 supported through three axially spaced, upwardly extending rod portions 48, 50, 52 (FIG. 2). The rod portions 48, 50, 52 are slidably fitted into tube portions 49, 51, 53 in the housing 4. Eight rocker arms 54 are pivotally connected to the pressure bar 46 to extend generally horizontally laterally to move in parallel pivotal directions as shown by arrow 56. Each rocker arm 54 moves in cooperation with a cam 30 and is connected to a power rod assembly 58. Each rocker arm 54 is of the same shape and may comprise a lower surface having a curved projection 60 which rides on the cam 30 and follows the cam through the edge variations described above. Alternatively, the projection 60 may comprise a roller bearing attached to the rocker arm. The outward portion 61 of the rocker arm is curved slightly downwardly so that the power rod assembly 58 joins the rocker arm at a portion thereof which is downwardly offset from the projection 60. A cavity portion 62 extends through the outward portion 61 of the rocker arm 54 to slidably receive a shaft 64 of the power rod assembly 58. A pin 66 pivotally supports and drivably engages a spring cup pivot 68 of the power rod assembly.

The power rod assembly 58 transmits reciprocal movement of its associated rocker arm 54 to a corresponding crank portion 22 (FIG. 1) of the crank shaft 20 and supplements this motion through expansion of a spring member 72.

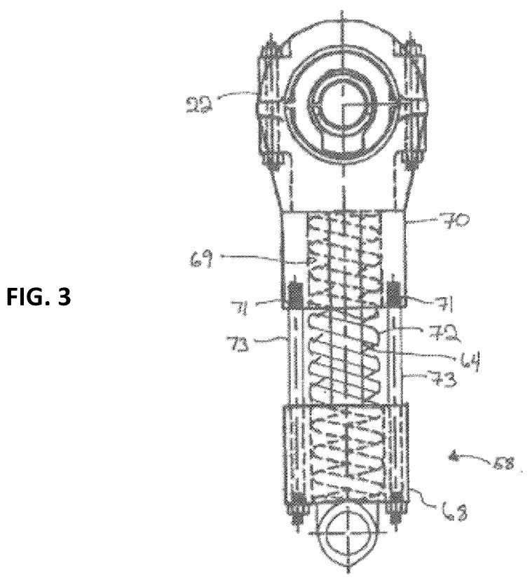

Turning to FIG. 3, each power unit assembly 58 comprises an upper nose piece 70, a coil spring 72, the shaft 64, and a spring cup pivot 68. The upper nose piece 70 is rotatably fixed to its associated cross piece 22 on the crank shaft 20 and terminates downwardly in rim portion comprising a spring receiving aperture 69 and two connecting rod apertures 71 to receive connecting rods 73. The coil spring 72 surrounds the shaft 64 and downwardly engages the spring cup 68. The shaft 64 is fixed to the nose piece 70 and extends to the spring cup 68 supported on the rocker arm 54. The spring cup 68 is pivotally supported on an upper surface of the rocker arm 54 and comprises an aperture to receive a lower coil of the coil spring 72. The power unit assembly 58 thus provides compressible, expansible connecting means translating the reciprocal pivotal movement of the rocker arm 54 brought about by the cam 30 into rotation of the crank shaft 20 accompanied by compression and expansion of the coil 72. Compression and expansion of the coil spring 72 takes place as the spring cup 68 rides on the rocker arm 54 and slides along the shaft 64 towards the nose piece 70.

The relationship between the various crank portions, cams, and springs is shown in the following table:

| | Crank | | Spring | Connecting |
|---|---|---|---|---|
| Composition | Shaft | Cam | Tension | Unit Number |
| 0 | Farthest | Maximum | Idle | 1 |
| 180 | Farthest | Intermediate | Idle | 2 |
| 270 | Closest | 0 | Compressed | 3 |
| 90 | Farthest | 0 | Idle | 4 |
| 315 | Closest | Minimum | 50% | 5 |
| | | | Compressed | |
| 135 | Farthest | Intermediate | Idle | 6 |
| 45 | 0 | Maximum | Idle | 7 |
| 225 | 0 | 0 | 50% | 8 |
| | | | Compressed | |

The above crank shaft positions are those which each individual crank portion goes through during a complete revolution and also those of each member at a given moment.

Returning to FIG. 1, the hydraulic a pump 12 of at least one embodiment is used to assist the throttle assembly 14. The throttle assembly 14 comprises two hydraulic fluid reservoirs, a power assist reservoir 80 and a master reservoir 82. The master reservoir 82 is the main reservoir and controls the amount of hydraulic pressure from pump 78 delivered through lines 84 to the tube portions 49, 51 and 53 of the rocker arm assembly 58. A source of electric energy 74 controlled by a switch 76 drives an electric pump 78 which develops pressure in the master reservoir 82. Pressure in the tube portions 49, 51 and 53 forces the rocker arm rods 48, 50 and 52 downward, pivoting the rest position of the rocker arms toward the crank shaft 20. Springs 86 in each tube 49, 51 and 53 help to force the rods 48, 50 and 52 downward to a rest position. Pressure in the tubes 49, 51 and 53 is increased through a sliding piston 87 in the master reservoir 82. The force from the pump 78 initiates and facilitates movement of the piston 87 to decrease reservoir area and increase pressure in the tubes 49, 51 and 53. The piston 87 is reciprocally movable through a shaft 88 connected to a second piston 90 in the power assist reservoir 80. The second piston 90 also moves forward to displace the first piston 87 to increase pressure in the tubes 49, 51 and 53. Pressure from the hydraulic pump 12 is delivered through lines 92, 94 to a first chamber portion 96 of the power assist reservoir 80 and a second chamber portion 98, containing the piston 90, of the power assist reservoir. Flow through the first chamber portion is controlled by a sliding plate 102. The sliding plate 102 is connected to a piston 104 in the first chamber portion 96 and controlled by a rod 106. Movement of rod 106 increases pressurized fluid flow to the second chamber portion 98 to move the piston 90 forward. The pump 12 is driven by a belt 108 from the cam shaft 8 so that increased motor rpm provides increased pressure for moving the pressure bar. The amount of this pressure delivered to the piston 90 is controlled by the plate 102. For maximum power output from the present apparatus, increased pressure is delivered to the pressure bar as cam shaft rpm increases. This pressure may be throttled back by movement of the plate 104 to cut off pressure to the piston 90.

The present apparatus may, in some exemplary embodiments, further comprise an oiling system. An oil hose 112 is connected to each one of the connecting shafts 64. Each shaft 64 has an oil channel running through the center of the shaft full length to two holes 114, 116, at the top of the nose piece 70. The hose 112 which is attached to the end of the connecting shaft 64 is also connected to a main oil line that is connected to an oil pump 118 driven by the cam shaft 8 through the use of a gear.

When oil is pumped up through the connecting shaft it oils bearings on each one of the crank shaft throws. It also oils and keeps the coil springs from getting hot and losing their tension. This is done by forcing the oil out through the two oil holes 114, 116 at the top of the nose piece 70 into a reservoir. This reservoir is created by the uses of a rubber shelf in the nose piece 70 that is clipped to the nose piece of the connecting rod and also dipped to a conventional spring cup and by forming a reservoir.

The rubber shelf has holes in it about ⅔ of the way up from the bottom of the shelf, allowing the oil to be forced out when the coil spring is being compressed and by doing this it stops the rubber shelf from ballooning. On the power stroke the cooled oil is forced back into the reservoir because the coil spring is being expanded allowing the oil to fill up the reservoir and cooling off the coil spring. The main bearings are oiled similarly. There are oil ports drilled in each one of the supports and an oil hose is connected to each one.

Turning to FIG. 4, an alternative cam configuration is shown. The cam 212 has a profile that varies in distance from the rotational axis 44 (FIG. 4) about 360 degrees. As discussed before eight (8) cams 212 are connected to the splined cam shaft 8 and spaced apart to engage the projections 60 formed on the lower portion of the rocker arms. Alternatively, the projections 60 (FIG. 2) may be replaced with roller bearings mounted to the rocker arms and disposed to roll along the cam edge 41 as the arms rise and fall. The cams 212 are mounted on the splined cam shaft 8 in a circumferentially offset relationship. In a preferred configuration cam 7 is offset 45 degrees from cam 1, cam 4 is offset 45 degrees from cam 7, cam 6 is offset 45 degrees from cam 4, cam 2 is offset 45 degrees from cam 6, cam 8 is offset 45 degrees from cam 2, cam 3 is offset 45 degrees from cam 8, cam 5 is offset 45 degrees from cam 3, and cam 1 is offset 45 degrees from cam 5. The importance of this offset assembly will be discussed hereinafter.

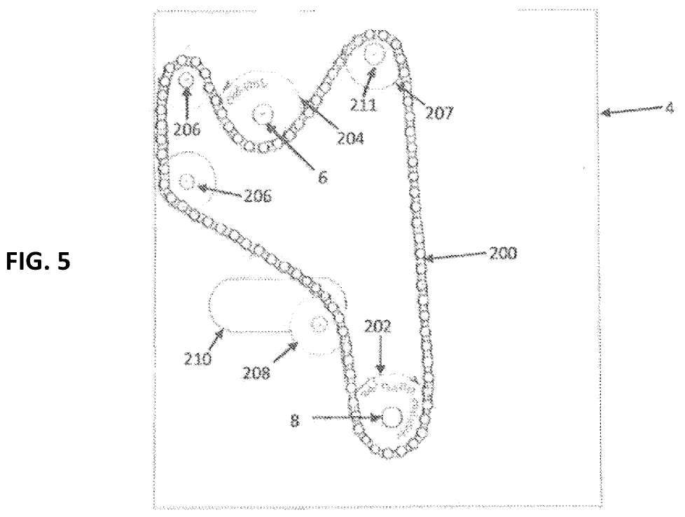

The cam 212 differs from cam 30 in the profile of its outer edge 41. Cams 212, like cam 30, may be divided into eight (8) sectors defined by 45 degrees of angular rotation. However, cam 212 has a generally kidney bean shape, the importance of which will become evident with further description. The cam profile is configured so that the spring 72 is idling during the rocker arms' travel from 315 degrees to 135 degrees. When the projection reaches 135 degrees, as the cam rotates counter-clockwise, the profile rises from 135 degrees to 225 degrees and comprises the compression stage edge 214. This rise comprises the compression phase of the cam's rotation. At 225 degrees the spring associated with the rocker arm is fully compressed and begins to lift the rocker arm and cause rotation of the crank shaft. The stored energy from spring 72 causes the rotation of the cam shaft and crank shaft via timing system (FIG. 5). As the cam 212 rotates to 270 degrees the spring has expended 50% of the compression energy. When the cam reaches 315 degrees the spring has released the compression energy acquired during the compression phase and entered an idle phase. The portion of the edge from 225 degrees to 315 degrees is the power stage edge 216. The edge from 315 degrees to 135 degrees is the idle stage edge 218. The spring remains in the idle phase as the cam rotates from 315 degrees back to 135 degrees.

The relationship between the cams and springs is shown in the following table:

| Cam | Angular Position | |
|---|---|---|
| Number | of Rocker Arm | Spring Tension |
| 1 | 0° | Idle |
| 2 | 180° | 50% Compressed |
| 3 | 270° | 50% expanded |
| 4 | 90° | Idle |
| 5 | 315° | 100% expanded |
| 6 | 135° | )% compressed |
| 7 | 45° | Idle |
| 8 | 225° | 100% Compressed |

The values in the table above cycle as the 100% and 50% compressed springs expand and cause the cam shaft to rotate to move the idle springs from an idle state to a compressed state.

Referring to the above table, the spring associated with cam 6 is 0% compressed. However, as cam 6 is rotated counterclockwise the distance between the cam shaft and the edge of the cam rises four (4) inches from 135 degrees to 225 degrees. This causes compression of the spring. As the cam continues to rotate from 225 to 315 degrees the spring decompresses and expands transferring the linear energy of the spring to cause rotation of the crank shaft. The distance between the cam shaft and the edge of the cam from 225 degrees to 315 degrees rises another 4.5 inches from the 225 degree location. At 315 degrees the spring has released its energy and enters an idle phase until the cam rotates around back to 135 degrees. At this point the cam profile begins to rise and compression of the spring is repeated.

Thus, while two springs are compressing at least two others are expanding to transfer rotational energy to the crank shaft and the remaining four are idling around from 315 degrees to 135 degrees to the next compression.

With reference to FIG. 5, the timing system of the present invention is shown. The motor is shown from a side on the outside of housing 4. The timing system comprises a timing chain 200 that is routed around a cam shaft wheel 202 connected to the cam shaft 8 for rotation therewith, a crank shaft wheel 204 connected to the crank shaft 6, and a plurality of toothed gears 206 and 207. Gear 207 is disposed on an output shaft 211 adapted to transfer the rotational output power of the motor to the implement driven by the motor. A tension adjustment assembly comprising a tension wheel 208 movable within a slot 210 formed within the housing 4 is used to adjust the tension on the chain 200. The timing system comprises five gears and/or pulleys that rotationally connect the cam shaft and the crankshaft to cause the cams 212 and cam shaft 8 to rotate, for example, counter clockwise while the crank shaft rotates clockwise and maintains the timing of rotation of the cam shaft relative to the crank shaft.

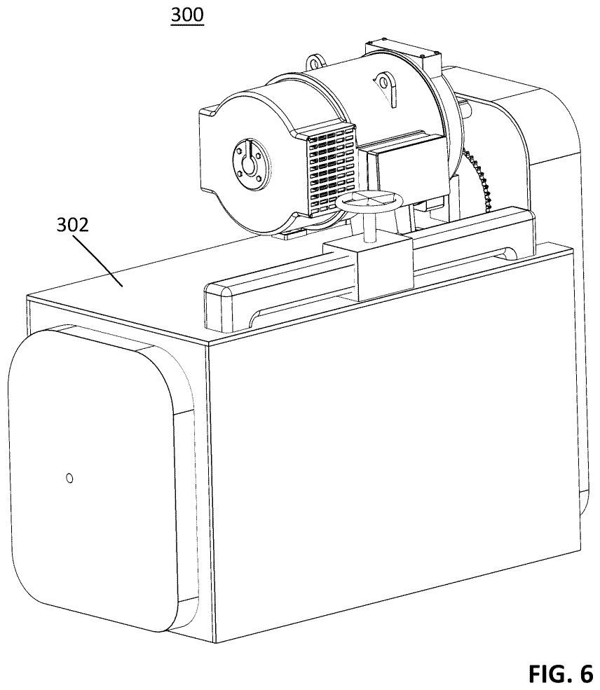

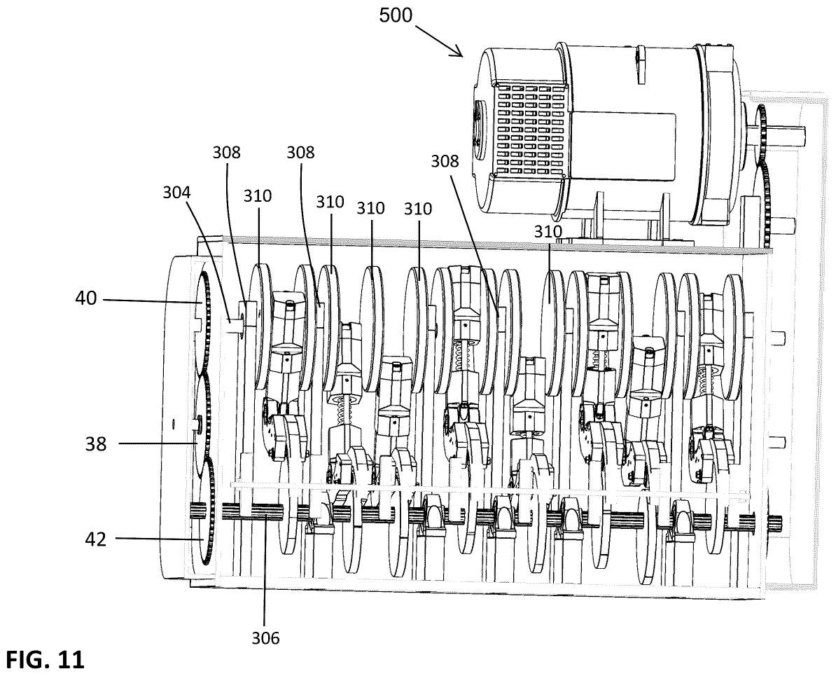

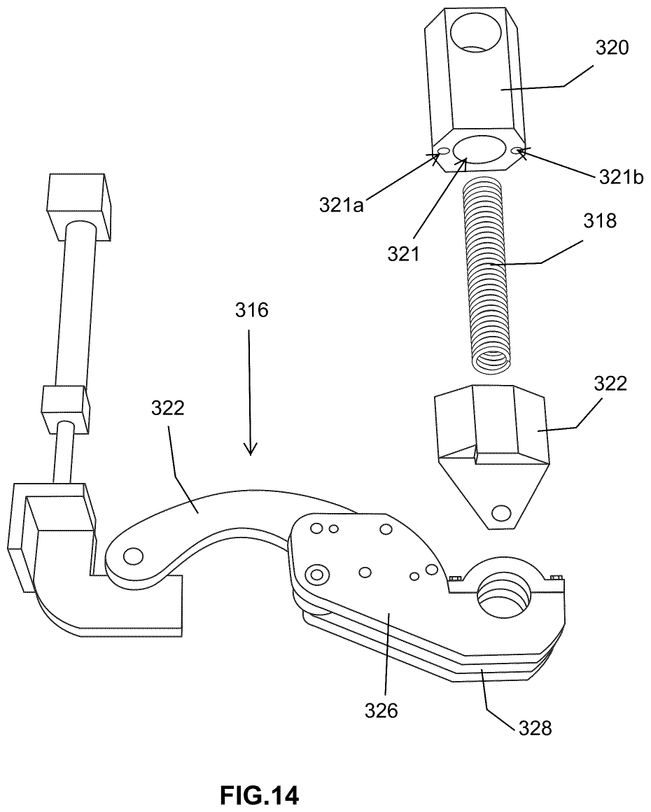

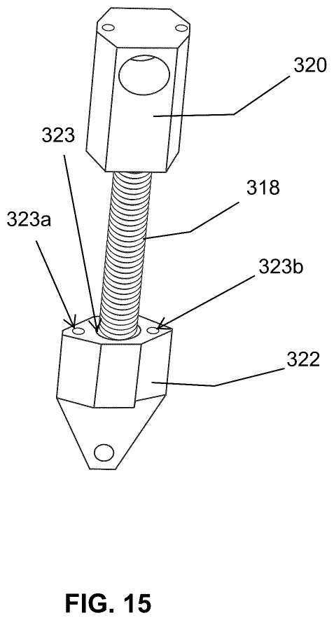

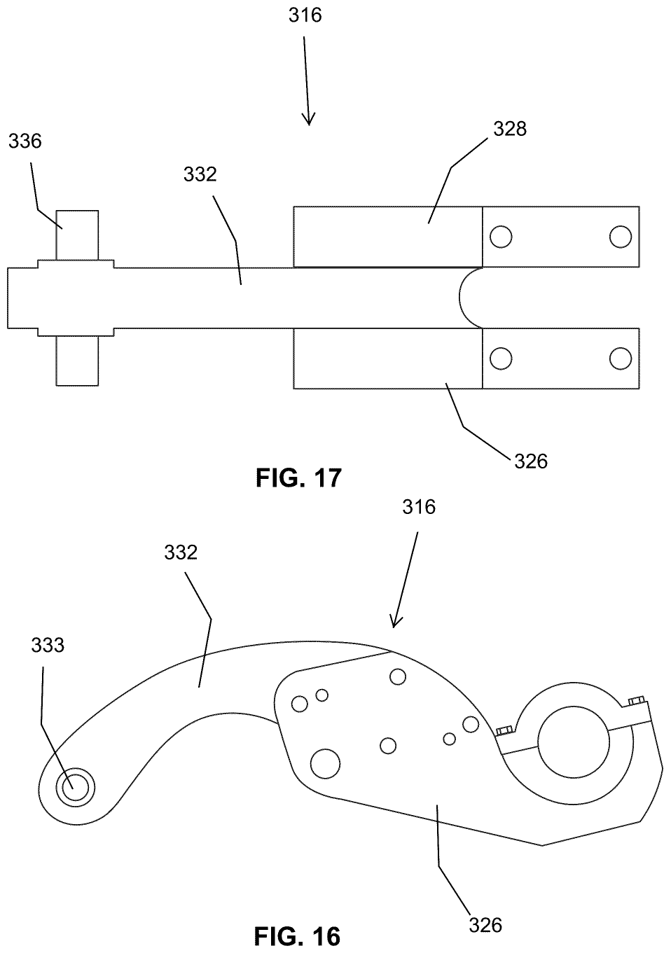

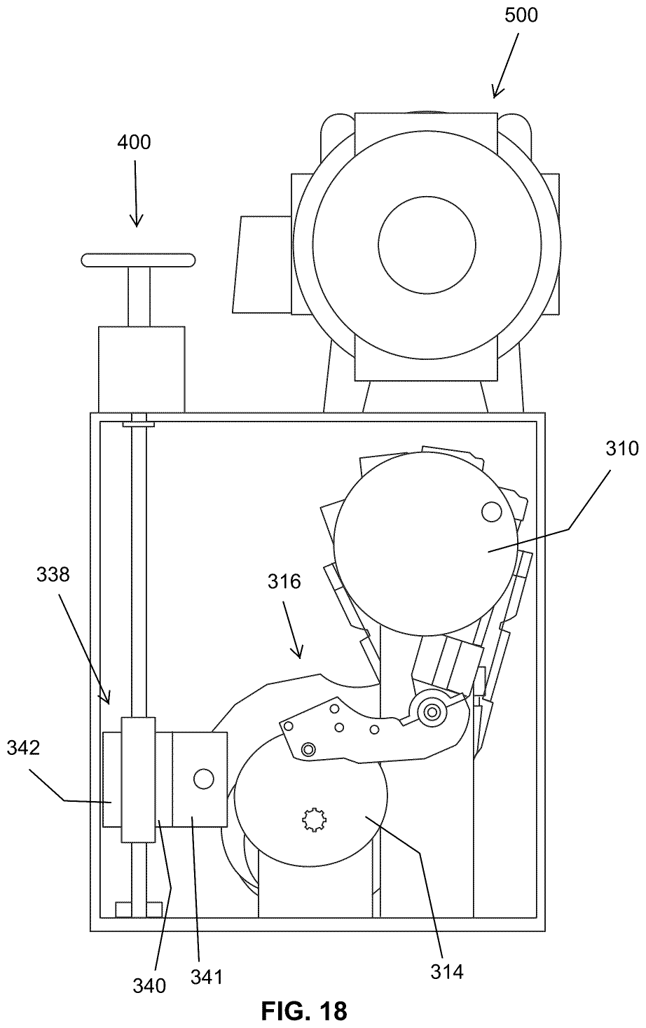

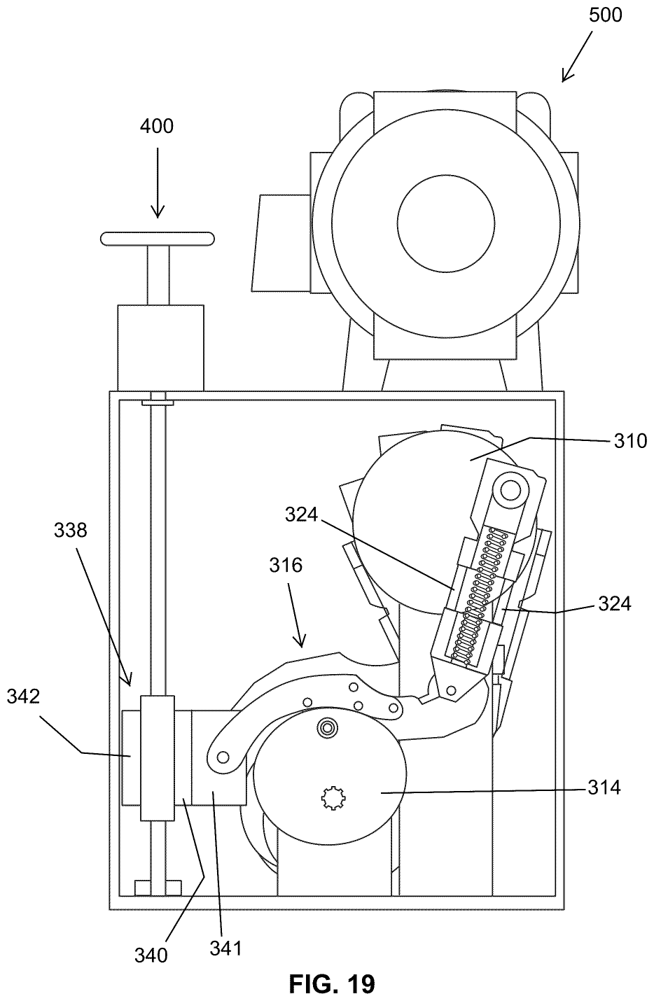

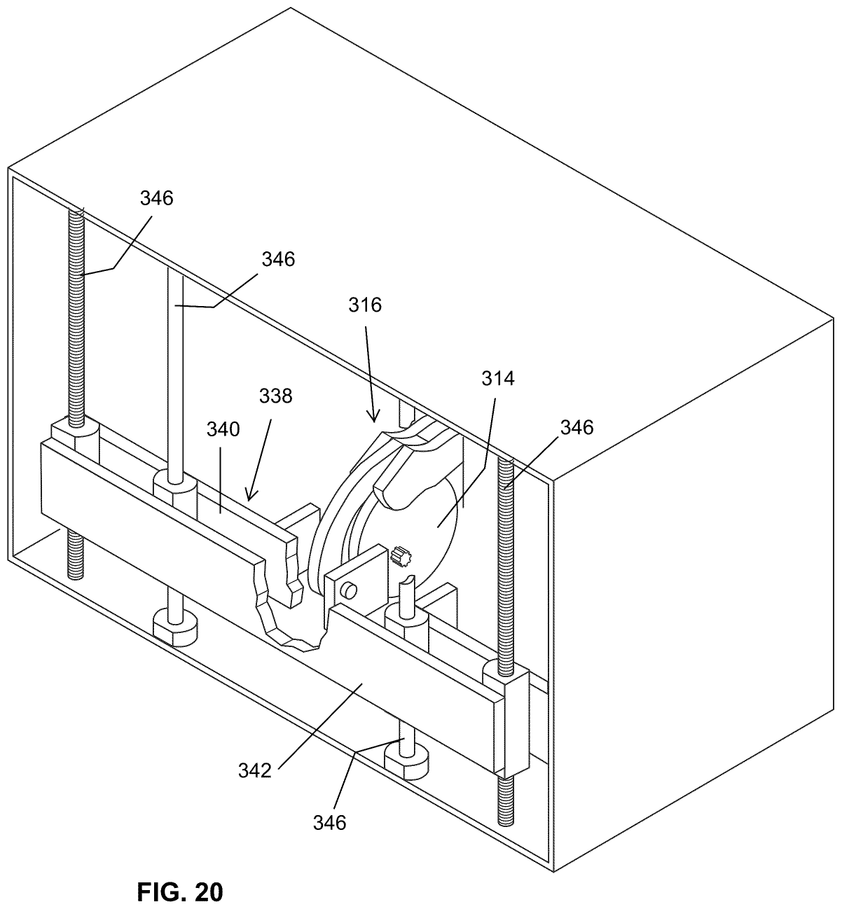

Turning now to FIGS. 6-22, another embodiment of a motor 300 is shown. The motor 300 is similar to the motor described with reference to FIGS. 1-5, although several improvements and modifications are included, as will be described herein.

In particular, with reference to FIG. 6-8, the motor 300 of at least one embodiment includes an outer housing, generally referenced as 302. The housing 302 shown in the figures has the shape of a rectangular prism, but may have other shapes, as desired.

A horizontally positioned crank shaft 304 and a horizontally positioned cam shaft 306 are supported within the housing 302. In at least one embodiment, each shaft 304 and 306 extends through opposed sides or walls of the housing 302 and each is rotatable relative to the housing 302. The crank shaft 304 is supported at an upper and rear end of the housing 302 by a plurality of vertical support members 308. The crank shaft 304 may have a split bearing. The crank shaft 304 of at least one embodiment may be shaped like crank shafts known in the art such that it includes a plurality of alternating upper and lower horizontal sections that are interconnected by a plurality of crank members 310.

The crank members 310 are positioned in a spaced relationship to one another. The crank shaft 304 may have external splines that interlock with internal splines formed in each crank member 310 or may be otherwise rigidly attached to each crank member 310. The crank members 310 of at least one embodiment have a circular or disk shape. The circular shape of the crank members may be advantageous over a non-circular shape because such shape allows the crank members 310 to rotate more efficiently. The circular shape also helps the crank members 310 generate kinetic energy as they rotate. Such energy helps continuous rotation of the motor 300, as described herein.

The cam shaft 306 is supported at a front and lower end of the housing 302. The cam shaft 306 may, in some cases, be held in place or at least partially held in place by a plurality of clamp members, generally referenced as 312, for example, in FIG. 9.

Furthermore, a plurality of cams 314 are disposed on or along the cam shaft 306 in a spaced relationship. The cam shaft 306 may have external splines that interlock with internal splines formed in internal axis holes each cam 314. The interlocking splines prevent the cams 314 from rotating relative to the cam shaft 306.

Each cam 314 is engaged with a lower surface of a rocker arm 316 in a one-to-one relationship. In at least one embodiment, the rocker arm 316 extends generally horizontally within the housing 302 and may be positioned at a right angle relative to the cam shaft 306 and the crank shaft 304. One end of the rocker arm 316 is positioned in front of the cam shaft 306 and an opposed end of the rocker arm 316 is positioned below the crank shaft 304. In at least one exemplary embodiment, as shown in the Figures, there are eight cams 314 and eight corresponding rocker arms 316. The rocker arm 316 will be described in more detail later herein.

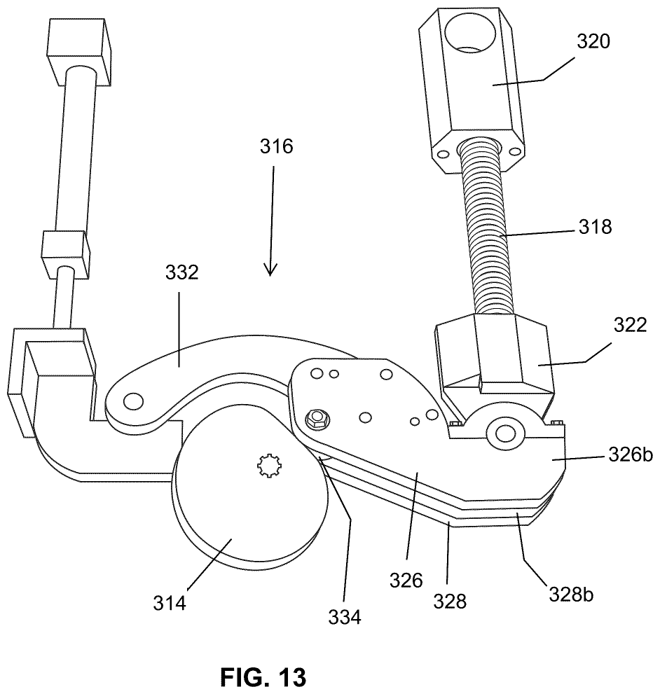

With reference to FIGS. 13-15, a plurality of springs 318 extend vertically within the housing 302 between the crank shaft 304 and an upper surface of each rocker arm 316. Each spring 318 is held within opposed upper and lower spring cups 320 and 322. Each upper spring cup 320 is pivotally attached to the crank shaft 304 between adjacent crank members 310. The upper spring cup 320 extends downward and an opening 321 of the upper spring cup 320 faces the lower spring cup 322. The lower spring cup 322 is pivotally attached to the rocker arm 316 and an outer surface of the lower spring cup 322 is engaged with the upper surface of the rocker arm 316. An opening 323 of the lower spring cup 322 faces the opening 321 of the upper spring cup 320. An end of each spring 318 is installed within each cup 320 and 322 such that the spring 318 interconnects each cup 320 and 322. The cups 320 and 322 are spaced apart from one another so that a mid-portion of the spring 318 is exposed to the interior environment of the housing 302.

Each cup 320 and 322 may be of single-piece construction or may be made of multiple pieces attached together. For example, the upper cup 320 may comprise an upper and lower piece fastened together around the crank shaft. In such case, the pieces may be separated in order to remove the upper cup 320 from the crank shaft 304, if needed. Such upper cup can be removed without having to remove the crank shaft 304.

The cups 320 and 322 are also interconnected by a pair of guide rods 324. A first end of each guide rod 324 is installed within openings 321a, 321b formed in the lower surface of the upper cup 320. A second opposed end of each guide rod 324 is installed within corresponding openings 323a, 323b formed in the lower cup 322. The guide rods 324 are positioned on opposite sides of the spring 318. The second end or lower end of the guide rods 324 are axially movable within the openings 323a, 323b formed in the lower cup 322 so that the lower cup 322 can move closer to the upper cup 320 during operation. The opposed ends or upper ends of the guide rods 324 are rigidly connected to the upper cup 320. In operation, as will be described in more detail herein, movement of the lower cup 322 towards the upper cup 320 compresses the spring 318. In alternative embodiments, the guide rods 324 may be rigidly connected to the lower cup 322 and axially moveable relative to the upper cup 320.

The upper and lower cups 320 and 322 are preferably sized to conform to the diameter of the spring 318. A sleeve may be installed within the opening 321, 323 of each cup 320, 322 to receive the spring 318, if the spring 318 is smaller than the openings 321, 322 of the cups 320, 322. The sleeves may vary in size as needed, depending on the size of spring used. The sleeves may be press-fit or interference fit within each cup.

As used herein, the upper and lower cups 320 and 322 and a corresponding spring 318 may be referred to as a power unit. In at least one embodiment, there are eight springs 318 and eight corresponding cups 320 and 322. The cups 320 and 322 and springs 318 correspond to one of the cams 314 and one of the rocker arms 316 in a one-to-one relationship. The crank shaft 306, crank members 310, cups 320 and 322 and springs 318 may be referred to as the power side of the motor 300.

Continuing with FIGS. 13-19, each rocker arm 316 comprises a first arm 326 rigidly attached to a second arm 328 in a side-by-side relationship. The first arm 326 comprises a first end 326a joined to an opposed second end 326b. The second end 326b is pivotally attached to a short cross-bar 330. Likewise, the second arm 328 comprises a first end 328a joined to an opposed second end 328b. The second end 328b of the second arm 328 is pivotally attached to the cross-bar 330 and is aligned with the second end 326b of the first arm 326.

The lower spring cup 322 is pivotally attached to the cross-bar 330 between the first and second arms 326 and 328. The second ends 326b, 328b of each arm 326 and 328, respectively, have a circular or rounded shape. The upper surface of the second ends 326b, 328b of each arm 326 and 328 is engaged with an outer lower surface of the lower spring cup 322. The second end of each arm 326 and 328 may comprise multiple pieces fastened together—one piece disposed over the cross-bar 330 and one below. Having multiple pieces allows the rocker arm to be more easily removed, if needed.

The rocker arm 316 further comprises a central or base arm 332 disposed between the first and second arm 326 and 328 at their first ends 326, 328a. A bearing or roller 334 is pivotally attached to each arm and is positioned between the first and second arms 326 and 328 and below a lower surface of the central arm 332. The roller 334 engages the outer surface of the cam 314.

The central arm 332 extends towards a front end of the motor 300 and has a curved shape. The first and second arms 326 and 328 also have a curved shape, but curve in the opposite direction of the central arm 332. Such curvatures help the arms 316 rock during operation.

Moreover, with reference to FIGS. 17, 18, 19 and 20, in at least one embodiment, the central arm 332 is attached to an elongate cross-bar 336. The cross-bar 336 is disposed through an eyehole 333 formed in each first arm 332 of each rocker arm 316. The cross-bar 336 is attached to a pressure bar or pressure bar assembly 338, for example, via a plurality of support plates 341. The pressure bar 338 comprises a first bar 340 and a reinforcing second bar 342. The bars 340 and 342 extend horizontally along the length of the housing 302. The support plates 341 are attached to the first bar 340 at a right angle and extend towards the rocker arms 316. The reinforcing second bar 342 helps stabilize the pressure bar 338 during operation. The pressure bar 338 is thus interconnected with the crank shaft 306 by way of the rocker arms 316 and power units.

The pressure bar 338 is movable up-and-down along a plurality of vertical guide rods 346. The rods 346 extend between upper and lower surfaces of the housing 302.

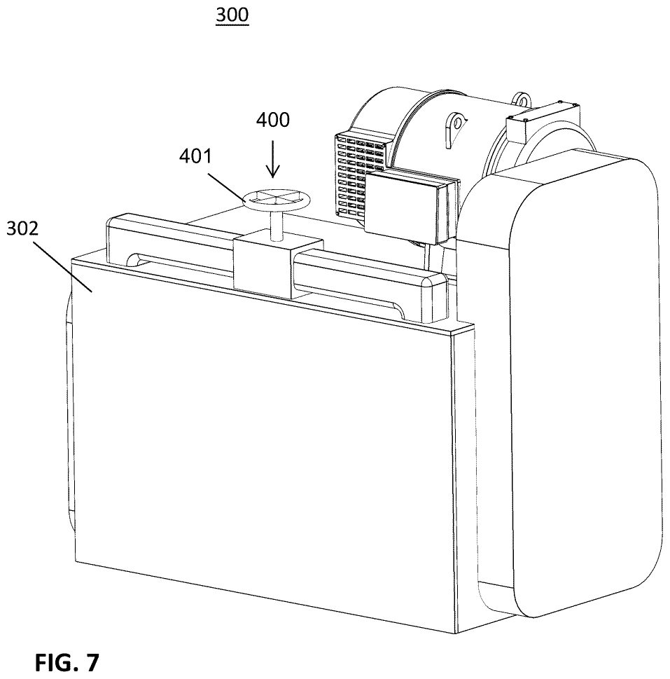

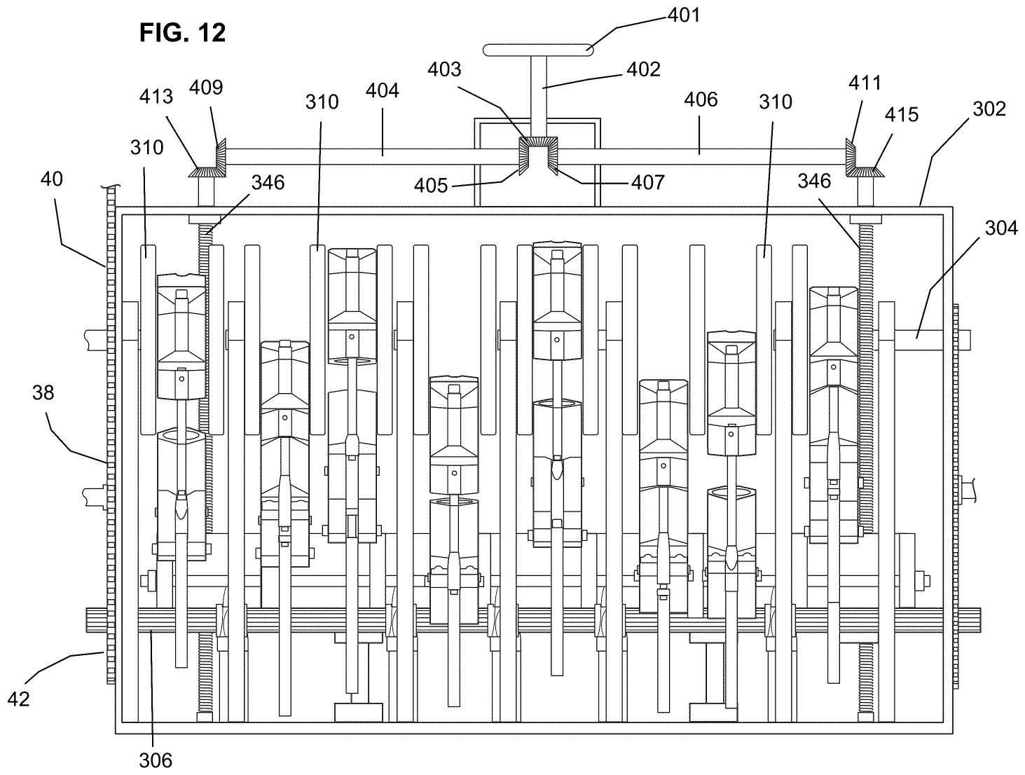

In the embodiment illustrated in FIGS. 12, 20, and 21 for example, movement of the pressure bar or pressure bar assembly 338 is accomplished through manual manipulation of a positioning assembly, generally referenced as 400. In this example or embodiment, a wheel 401 may be disposed or otherwise accessible external to the housing. Movement or manual manipulation of the wheel 401 in one direction will cause the pressure bar or assembly 338 to rise up, for example, along rods 346 toward the top of the housing. Similarly, movement or manipulation of the wheel 401 in the other direction will cause the pressure bar or assembly 338 to lower down, for example, along rods 346 in a direction toward the bottom of the housing. It should be noted that the wheel 401 shown in FIGS. 7, 12 and 21 is an example of manually manipulable device that can activate the positioning assembly 400. For instance, in other embodiments, a lever, crank, pump, etc. may be used.

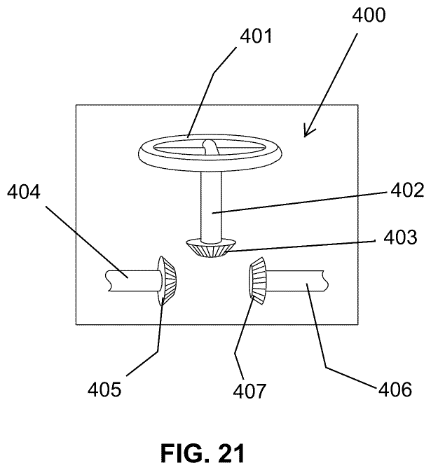

With reference to FIGS. 12 and 21, the positioning assembly 400 of at least one embodiment includes a shaft 402 fixed at one end to the wheel 401 or other like structure or device, with a gear (e.g., a bevel gear) 403 at the other end. Corresponding gears (e.g., bevel gears) 405, 407 are engaged with the gear 403 and extend from corresponding intermediate shafts 404, 406. As shown in FIG. 12, the intermediate shafts 404, 406 terminate at opposing ends with additional gears (e.g., bevel gears) 409, 411. Those gears 409, 411 engage with corresponding gears (e.g., bevel gears) 413, 415 which are attached to or engage with one or more of the rods 346. At least a portion of the rods 346 may be threaded in order to facilitate the movement of the pressure bar 338 there along.

It should be noted that other embodiments of the present invention may operate the movement of the pressure bar 338 in other manners, whether manual, power drive, pneumatic, electric, etc., and may include a series of different gears or connections.

As just an example, in at least one embodiment, movement of the pressure bar 338 may be controlled by one or more hydraulic cylinders. In such an embodiment, the pressure bar 338 moves using hydraulic pressure as described with reference to FIGS. 1-6. The hydraulic cylinders may be connected to the hydraulic power unit, described above, and as referenced as 12.

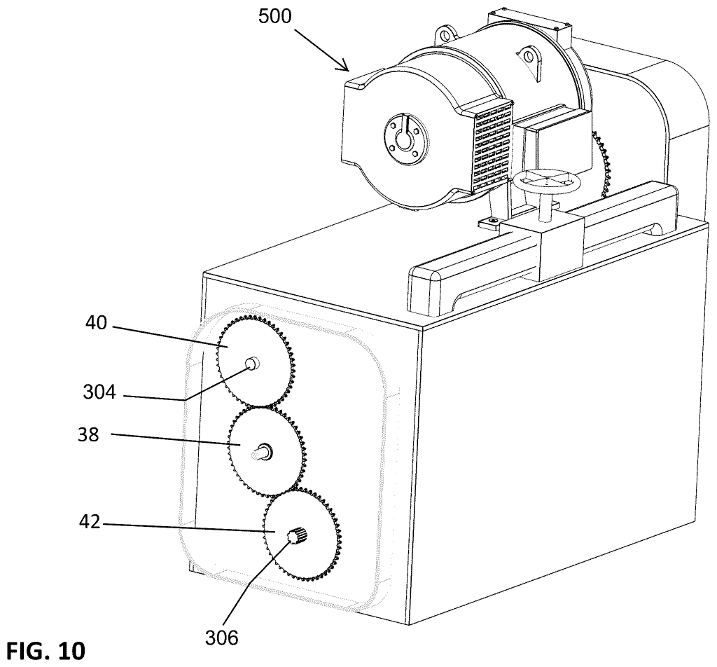

In particular, downward movement of the pressure bar 338 pivots the rocker arms 316 and starts rotational movement of the crank and cam shafts 304 and 306. The cam shaft 304 and the crank shaft 306 of at least one embodiment are interconnected by a timing gear 38, however, other embodiments may include a timing chain or other like device or structure. For instance, with reference to FIG. 10, a first gear 42 is attached to the cam shaft 306 and a second gear 40 is attached to the crank shaft 304. The intermediate or timing gear 38 may be engaged with both gears 40, 42, as shown in FIG. 10. In other embodiments, a timing chain may be disposed around the first and second gears 40, 42. In any case, the timing gear 38 or chain helps keep the shafts 306 and 304 rotating together at the desired speed.

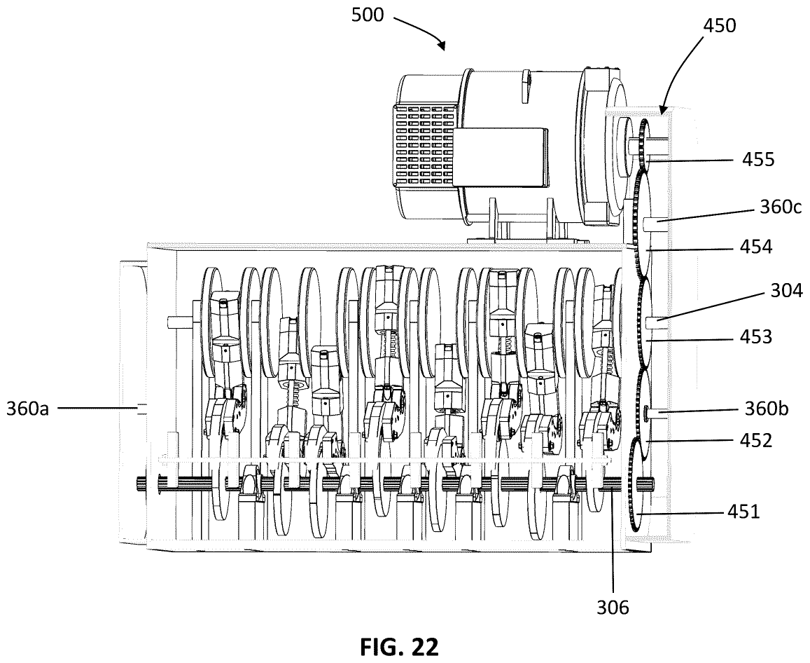

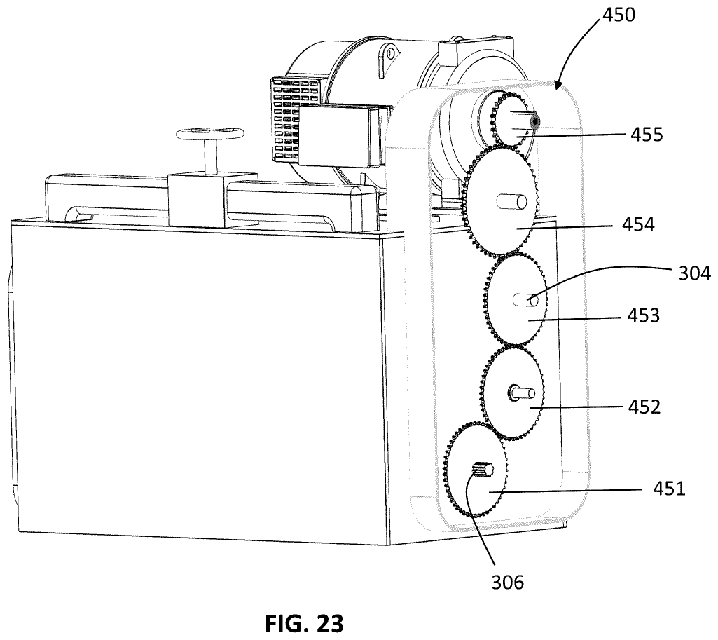

With reference now to FIGS. 22 and 23, in at least one embodiment another set of gears, generally referenced as 450, may be included. In particular, gear 451 may be connected to and rotatable with the cam shaft 306, and gear 453 may be connected to and rotatable with crank shaft 304. An intermediate gear 452 may be disposed between and interconnected to both gears 451, 453. Another intermediate gear 454 may be included and engaged with the crank shaft gear 453 such that it also rotates therewith. This intermediate gear 454 may rotate a gear 455. Gear 455 may be attached to a generator 500. It should be noted that other gears, interconnections, or timing chains may be implemented in order to accomplish a similar goal of driving the generator gear 455 with the rotation of the cam and crank shafts.

In particular, a pump gear may be mechanically coupled to a hydraulic pump. Rotation of the pump gear supplies power to the hydraulic pump. As described above, the hydraulic pump of at least one embodiment of the present invention supplies hydraulic pressure to the hydraulic cylinders to hold the pressure bar 338 in the desired position.

In operation of at least one embodiment of the present invention, the pressure bar 338 is lowered to engage the rocker arms 316. Movement of the rocker arms 316 activates rotation of the cam shaft 306. Rotation of the cam shaft 306 causes the crank shaft 304 to start to rotate in response to rotation of the second gear(s) 40, 453 caused by movement of the timing gear(s) 38, 452. As the cam shaft 306 and crank shaft 304 are turning, for example, counterclockwise to each other, the motor 300, and in particular, the cams and rocker arms, of at least one embodiment is/are oriented such that, during at least one phase of rotation, three cams 314 are pushing up three rocker arms 316 in position to compress the corresponding springs 318. As the rotation continues to take place, three rocker arms 316 in position are pushing up on the lower spring cups 322. The springs 318 are preferably compressed ⅓ of their specification. For example, a 9.00 long spring may be compressed to 6.00. At any time when the motor 300 is operating, there are at least three springs 318 under compression—at least two in the holding zone and at least one in the compression zone. Springs 318 that are compressed are always in three positions: at 225 degrees the spring is fully compressed (condensed by 3.00); at 270 degrees, the spring is 50% compressed and holding (condensed by 1.50); at 180 degrees, the spring is 50% compressed (condensed by 1.50).

To turn off the motor 300, the pressure bar 338 is raised and disengaged with the rocker arms 316. When pressure is no longer applied to the rocker arms 316 by the pressure bar 338, the cam shaft 306 stops rotating, which stops rotation of the crank shaft 304. The RPM or speed of the motor 300 can be increased by applying more pressure to the pressure bar 338 (lowering the pressure bar further), or by decreasing the pressure applied to the pressure bar 338 (raising the pressure bar).

As just an example, if the motor 300 is compressing 500 pounds (lbs.) during operation, there will always be 2000 pounds (lbs.) of pressure output by the motor 300. Compression values are determined by the size and length of the springs and the pressure applied to initiate rotation of the cam shaft 306. There is preferably always a 3 to 1 ratio within the motor 300. Compression from the power side preferably always equals 3× the amount of pressure needed to compress one spring 318 in the power unit.

In operation, no continuous external power is needed to operate the motor 300 because the power is lock-in and becomes transitional power, going from one power unit to the next 1-8 then repeats the cycle as the motor 300 continues to run. Because no continuous external power is needed to operate the motor, the motor can function without the use of fossil fuels, thereby helping to eliminate greenhouse gases.

As described above, the downward (and/or upward) movement of the pressure bar 338 of at least one embodiment is caused through manual manipulation of a wheel or other like lever or device. In other embodiments, the movement of the pressure bar 338 may be accomplished through power supplied by a hydraulic pump, power supplied by an electric pump, or other means.

With reference to FIGS. 10, 11, and 22, the motor 300 of at least one embodiment includes at least one output section or shaft 360a, 360b, 360c. The output section(s) 360a-c may extend from any one or more of the gears, such as timing gears 38, 452, 454. In other embodiments, the output section(s) or shaft(s) may extend from the cam shaft 306, crank shaft 304 or other rotatable shaft or gear of the present invention.

In any case, the output section(s) or shaft(s) 360a-c may be attached to an external apparatus or device that is able to be powered by the motor 300. For example, a generator 500 may be attached to the output section in the manner described above with reference to gears 450. In other cases, the motor 300 of the various embodiments of the present invention may be used with any number of devices, such as a generator, car, plane, or any other device that requires power.

Furthermore, the motor 300 may be sized to fit within different apparatuses, as desired. For example, the motor 300 may be sized to fit within a car or may be sized for use with a hydraulic plant or jet plane. The motor 300 may also comprise less than eight or more than eight cams, rocker arms, and power units, as desired.

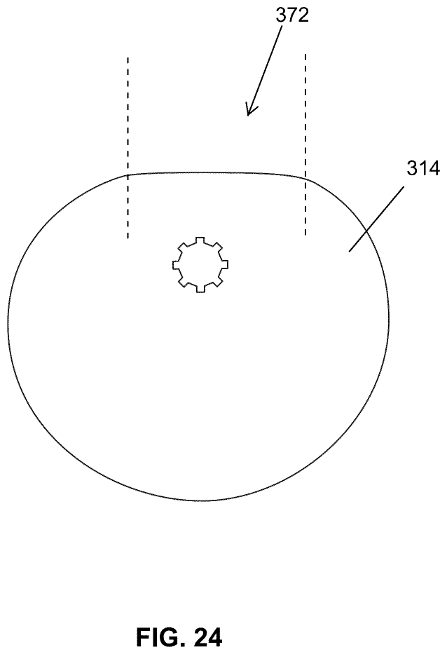

With reference to FIG. 24, the cam 314 used with at least one embodiment of the motor 300 is shown in more detail. In particular, the cam 314 has a different shape than the cam 212 shown in FIG. 4. The cam 314 does not include the divot, groove, or cut-out section 370 shown in the cam 212. The cut-out portion 370 was found to cause rough movement of the rocker arms. In some cases, the rocker arm would pop off of the cam when it hit such cut-out, causing the rocker arm to jump and loose contact with the cam.

More in particular, and still referring to FIG. 24, the cam 314 of at least one embodiment is flat in the area of the cut-out, as shown by section 372 in FIG. 24. As the cam 314 rotates, it never loses contact with the roller or rocker arm, ensuring smooth motion of the rocker arm. In alternative embodiments, the cam may have a fully circular shape.

Various modifications can be made in the design and operation of the present invention without departing from the spirit thereof. Thus, while the principle preferred construction and modes of operation of the invention have been explained in what is now considered to represent its best embodiments, which have been illustrated and described, it should be understood that the invention may be practiced otherwise than as specifically illustrated and described.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention. This written description provides an illustrative explanation and/or account of the present invention. It may be possible to deliver equivalent benefits using variations of the specific embodiments, without departing from the inventive concept. This description and these drawings, therefore, are to be regarded as illustrative and not restrictive.

1. A motor comprising:
a rotatable cam shaft,
a plurality of cams axially spaced along a length of said rotatable cam shaft, each of said plurality of cams being fixed to said rotatable cam shaft for rotation therewith,
a plurality of rocker arms, each of said plurality of rocker arms corresponding with a different one of said plurality of cams,
each of said plurality of rocker arms comprising a first end attached to a pressure bar assembly, and a second end connected to a power unit,
each of said power units comprising a lower spring cup, a spring and an upper spring cup, said lower spring cup being attached to a corresponding one of said plurality of rocker arms,
a rotatable crank shaft engaged with each of said power units, and
wherein each of said plurality of cams comprises a substantially circular shape with at least one portion defined by a linear outer surface.

2. The motor as recited in claim 1 wherein said rotatable crank shaft comprises a plurality of disk-shaped crank members.

3. The motor as recited in claim 2 wherein said upper spring cup of each of said power units is attached to said rotatable crankshaft between adjacent ones of said plurality of disk-shaped crank members.

4. The motor as recited in claim 3 wherein said upper spring cup of said power unit comprises an opening within which a portion of said spring is disposed.

5. The motor as recited in claim 4 wherein said lower spring cup comprises an opening within which a portion of said spring is disposed.

6. The motor as recited in claim 1 wherein said rocker arm comprises a first arm and a second arm disposed in a spaced, side-by-side relation to one another.

7. The motor as recited in claim 6 wherein said rocker arm further comprises a base arm defining a first end and a second end, wherein said first end of said base arm is attached to said pressure bar assembly and wherein said second end of said base arm is mounted to and between said first arm and said second arm.

8. The motor as recited in claim 1 wherein said pressure bar assembly comprises at least one elongated bar extending across an interior portion of a housing, said elongated bar being movable along a vertical axis within said housing.

9. The motor as recited in claim 8 wherein said pressure bar assembly comprises at least two bars disposed in a parallel relation to one another, and a plurality of support plates extending from at least one of said at least two bars.

10. The motor as recited in claim 9 wherein each of said plurality of rocker arms is mounted to a different one of said plurality of support plates.

11. The motor as recited in claim 10 wherein said pressure bar assembly is manually manipulated via a positioning assembly.

12. The motor as recited in claim 10 wherein said pressure bar is hydraulically operated.

13. The motor as recited in claim 1 wherein at least one of said springs of said power unit is in a compressed state, while at least a different one of said springs is in a relaxed state.

14. A motor comprising:
a rotatable cam shaft,
a plurality of cams axially spaced along a length of said rotatable cam shaft, each of said plurality of cams being fixed to said rotatable cam shaft for rotation therewith,
a plurality of rocker arms, each of said plurality of rocker arms corresponding with a different one of said plurality of cams,
each of said plurality of rocker arms comprising a first end attached to a pressure bar assembly, and a second end connected to a power unit,
a rotatable crank shaft engaged with each of said power units,
wherein each of said plurality of rocker arms comprises a first arm, a second arm and a base arm, wherein said first arm and said second arm are disposed in a spaced, side-by-side relation to one another, and
wherein said base arm comprises a first end and a second end, said first end of said base arm being attached to said pressure bar assembly and said second end of said base arm being mounted to and between said first arm and said second arm.

15. The motor as recited in claim 14 wherein said rotatable crank shaft comprises a plurality of disk-shaped crank members.

16. The motor as recited in claim 15 wherein each of said power units comprise a lower spring cup, a spring and an upper spring cup, said lower spring cup being attached to a corresponding one of said plurality of rocker arms, and wherein said upper spring cup is attached to said rotatable crankshaft between adjacent ones of said plurality of disk-shaped crank members.

17. The motor as recited in claim 16 wherein said upper spring cup and said lower spring cup each comprise an opening within which opposing ends of said spring is disposed.

18. The motor as recited in claim 14 wherein said pressure bar assembly comprises at least one elongated bar extending across an interior portion of a housing, and a plurality of support plates extending there from, said elongated bar together with said plurality of support plates being movable along a vertical axis within a housing.

19. The motor as recited in claim 14 wherein each of said plurality of cams comprises a substantially circular shape with at least one portion defined by a linear outer surface.
